(19) United States
(12) Patent Application Publication
(10) Pub. No.: US 2016/0189112 A1
(43) Pub. Date: Jun. 30, 2016

(54) MANAGEMENT ACTIONS FOR CALENDAR CONFLICTS

(71) Applicant: HEWLETT-PACKARD DEVELOPMENT COMPANY, L.P., Houston, TX (US)

(72) Inventors: Adi Kidron, Yehud (IL); Erez Yaary, Yehud (IL); Oded Klimer, Yehud (IL); Yael Keren, Yehud (IL)

(73) Assignee: HEWLETT-PACKARD DEVELOPMENT COMPANY, L.P., Houston, TX (US)

(21) Appl. No.: 14/909,504

(22) PCT Filed: Aug. 27, 2013
(86) PCT No.: PCT/US2013/056711

§ 371 Date: Feb. 2, 2016

(51) Int. Cl. G06Q 10/10

(52) U.S. Cl. CPC G06Q 10/1095

(57) ABSTRACT

In one example of the disclosure, a current meeting invitation to a user is accessed. There is a current timing conflict between the current invitation and a subject calendar event of the user. A relevant behavior is identified. The relevant behavior is with respect to a previous meeting invitation sent to the user, the previous invitation having a conflict with a calendar event and a common invitation attribute with the current invitation. A management action is applied, in consideration of the relevant behavior, to the current timing conflict.

### BACKGROUND

Handheld computing devices, notebook computers, desktop computers, smartphones and other computing devices frequently have installed a calendar application that provides an electronic version of a calendar. A user may populate the electronic calendar with events (e.g., appointments, meetings, or anniversaries) that are to take place at a certain time, and location.

### DRAWINGS

FIG. 1 is a block diagram depicting an example environment in which various embodiments may be implemented.

FIG. 2 is a block diagram depicting an example of a system for applying management actions to calendar conflicts.

FIG. 3 is a block diagram depicting an example data structure for applying management actions to calendar conflicts.

FIG. 4 is a screen view of an example user interface.

FIG. 5 is a block diagram depicting a memory resource and a processing resource according to an example.

FIG. 6 is a flow diagram depicting steps taken to implement an example.

FIG. 7 is another flow diagram depicting steps taken to implement an example.

### DETAILED DESCRIPTION

### Introduction

The electronic calendar application in many cases is networked solution that allows for the sharing of information between users. The calendaring application typically allows individual calendar users to send invitations, accept invitations, send counterproposals, and otherwise negotiate scheduling of a meeting or other proposed event. From the perspective of the person sending the invitation, a major goal in sending the application is to select a time for the even that will permit a high number of the invitees to attend.

Finding a common free time slot for a meeting across multiple calendars can be challenging, however. In a large organization often you see a situation where a meeting organizer desires to schedule a meeting with a large number of invitees, or to move an existing meeting to a different slot. This task can be often become time consuming, tedious, and inefficient. For example, a meeting organizer may find it necessary to contact his or her team members to request that the team members move meetings or to understand the priorities of the team members' other meetings.

To address these issues, various embodiments described in more detail below provide for applying management actions to calendar conflicts. Examples described herein may operate by accessing a current meeting invitation to an invitee user, wherein there is a timing conflict between the current invitation and another calendar event of the invitee user. Data indicative of a set of calendar events, and data indicative of a set of past behaviors of the invitee user following the invitee user's receipt of meeting invitations, may be accessed. A relevant behavior can be identified from the past behavior data. A management action can then be determined in consideration of identified relevant behavior, and applied to the current timing conflict.

In an example described herein, the relevant behavior is with respect to a previous meeting invitation that was sent to the invitee user and that has a same invitation attribute as does the current invitation. In examples, the invitation attribute may include at least one of a meeting type, a meeting subject, an invitee, and a number of invitees or participants. In another example described herein, the relevant behavior may be identified with respect to multiple previous meeting invitations sent to the invitee user and having the same invitation attribute, with determination and application of the management action occurring in consideration of a count of occurrences that the invitee user exhibited the relevant behavior. In examples, the relevant behavior may be the user causing sending of a rejection message or a timing counterproposal. In other examples, the relevant behavior may be a failure to respond to a meeting invitation.

In examples, the relevant behavior may be a failure to attend all or part of a meeting. In examples, the presence data may be accessed, e.g., from a computing device associated with the invitee user, and utilized in identifying the failure to attend. In a particular example, the presence data may include includes positioning data or motion analytics data. In other examples, the user's failure to attend all or part of a meeting may be identified by failure of the user to access a telephone connection, web application, or network designated in a meeting invitation.

In examples, the management action may include at least one of removing the invitee user from the current meeting invitation, sending a message to the invitee user requesting rescheduling of the subject calendar event, and changing the time or date of the current meeting invitation. In an example described herein, the management action may be sent to a computing device as a recommendation to be displayed to the invitee user, or to another user, e.g., a meeting organizer that initiated sending of the current meeting invitation to the invitee user.

In examples, the management action to be applied to the current timing conflict may be determined in consideration of the relevant behavior and a priority level of the subject calendar event. In an example, the priority level may be a priority level that has been derived based upon a rule that assigns the priority level according to a number of invitees or participants for the subject calendar event. In another example, the priority level may be a priority level that has been derived based upon a rule that assigns the priority level according to whether the invitation for the subject calendar event was sent by, or includes, a key user.

In an example of the disclosure, data may be accessed to cause a calendar-view display of the subject calendar event that is viewable by the meeting organizer. The display may include a representation of the invitee user, and an indicator of the priority level of the subject calendar event that is in timing conflict with the current meeting invitation. The priority level may be a priority level determined according to a rule that assigns the priority level according to a number of invitees or participants for the subject calendar event, or according to whether the invitation for the subject calendar event was sent by, or includes, a key user. In a particular example in which the subject calendar event has multiple invitees, the priority level indicator that is displayed is an indicator representative of an average priority of the subject calendar event in consideration of the multiple of invitees.

In this manner, embodiments of this disclosure present an automated and efficient manner to enable a meeting organizer to apply a management action to a situation where a current meeting invitation conflicts with another meeting invitation, a previously scheduled meeting, or other calendar event. Users of electronic calendars, especially users in environments where there are frequent meetings with a large number of invitees, will appreciate the ability to reconcile schedule conflicts and schedule meetings with fewer clicks and without a need for offline discussions between the meeting organizer and the invitees. Such advantages of the disclosure will cause customer satisfaction with electronic calendars and scheduling systems, and their providers, to increase.

The following description is broken into sections. The first, labeled “Components,” describes examples of various physical and logical components for implementing various embodiments. The second section, labeled as “Operation,” describes steps taken to implement various embodiments.

### Components

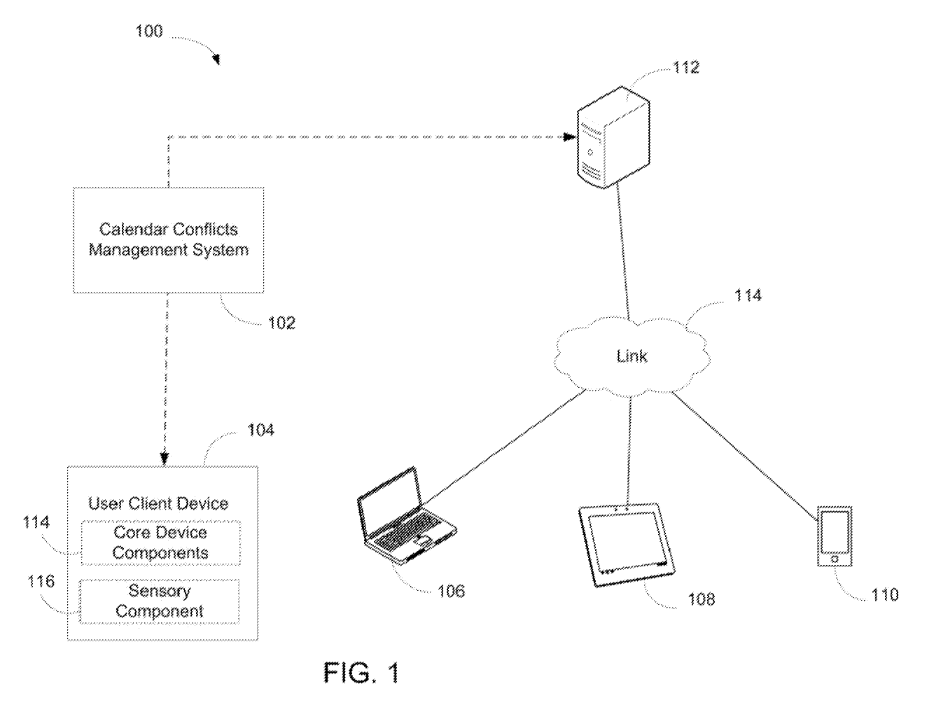

FIG. 1 depicts an example environment 100 in which embodiments may be implemented as calendar conflicts management system 102. Environment 100 is show to include client devices 104, 106, 108, and 110, and a server device 112. Components 104-112 are interconnected via link 114. Link 114 represents generally any infrastructure or combination of infrastructures configured to enable electronic communication between components 104-112. For example, link 114 may represent the internet, one or more intranets, and any intermediate routers, switches, and other interfaces. Client devices 104-110 represent generally any computing device with which a user may interact to communicate with other client devices and server device 112 via link 114. Server device 112 represents generally any computing device configured to serve an application and corresponding data for consumption by client devices 104-110.

Client device 104 is shown to include core device components 114 and sensory component 116. Core device components 114 represent generally the hardware and programming for providing the computing functions for which device 104 is designed. Such hardware can include a processor and memory, display and any physical user input buttons. The programming can include an operating system and applications. Sensory component 116 represents generally any component configured to detect a change in presence of client device 104 or an invitee user of client device 104. For example, sensory component may include any of a geographic information system (“GIS”), a Global Positioning System (“GPS”), or other positioning feature, an accelerometer, a motion analytics feature, and a communication feature that can be used to detect device position and/or motion. Sensory component 116 may be software configured to detect the start and stop of phone calls, virtual meetings, and other events where the client device facilitates interaction between the user and another individual via a network other communication channel.

Calendar conflicts management system 102, discussed in more detail below, represents generally a combination of hardware and programming configured to apply management actions to calendar conflicts. Briefly, calendar conflicts management system 102 is configured to access a current meeting invitation sent to a user, access data indicative of calendar events, access data indicative past behaviors of the user following receipt of a meeting invitation, identify a relevant behavior with respect to a previous meeting invitation having a same invitation attribute as the current invitation, and apply, in consideration of the relevant behavior, a management action to the current timing conflict. System 102 may be wholly integrated within core device omponents 114. System 102 may be implemented as a component of server device 112 where it takes action based in part on data received from core device components 114 and sensory component 116 via link 114. System 102 may be distributed across client device 104 and server device 112 where, for example, where, for example, identification of a relevant behavior of failure to attend all or part of a meeting is performed on device 104, and accessing a current meeting invitation sent to a user, accessing data indicative of calendar events, accessing data indicative past behaviors of the user following receipt of a meeting invitation, identifying a relevant behavior with respect to a previous meeting invitation having a same invitation attribute as the current invitation, and application, in consideration of the relevant behavior, of a management action to the current timing conflict are performed by server device 112. It is noted that all or portions of the calendar conflicts management system 102 may also be included on client devices 106, 108 or 110.

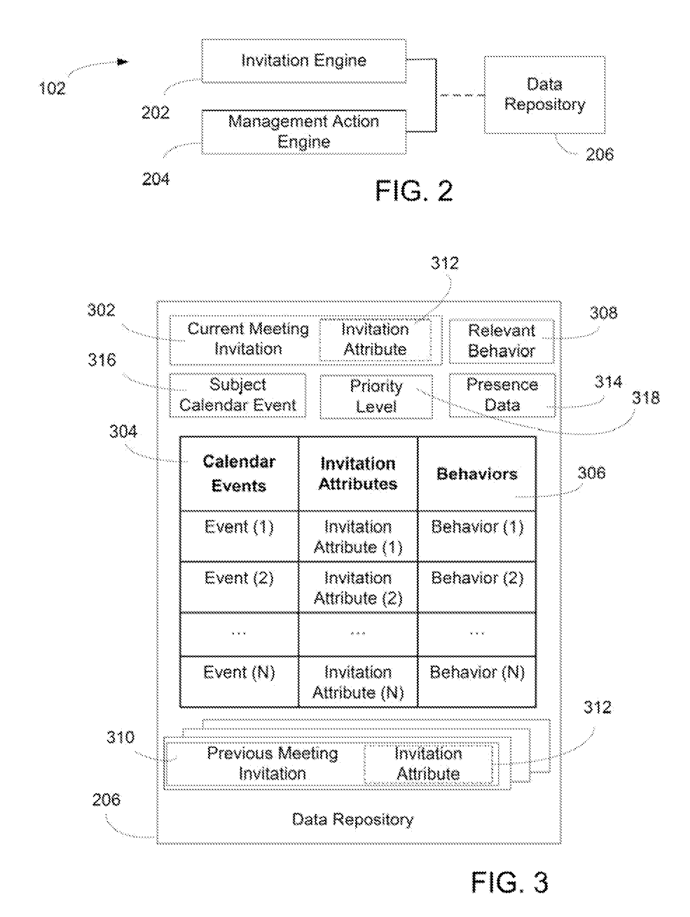

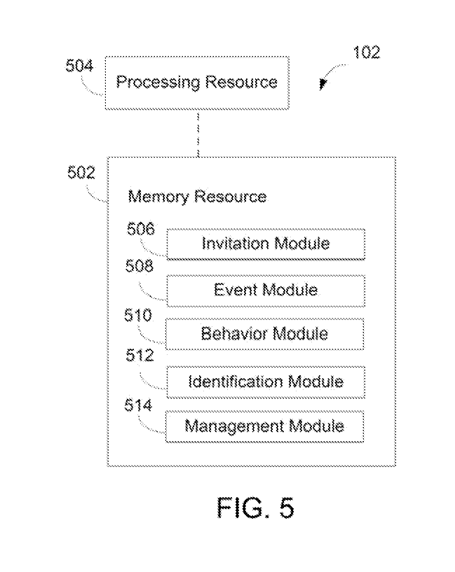

FIGS. 2-4 depict examples of physical and logical components for implementing various embodiments. In FIG. 2 various components are identified as engines 202, 204. In describing engines 202, 204, focus is on each engine's designated function. However, the term engine, as used herein, refers generally to a combination of hardware and programming configured to perform a designated function. As is illustrated later with respect to FIG. 5, the hardware of each engine, for example, may include one or both of a processor and a memory, while the programming may be code stored on that memory and executable by the processor to perform the designated function.

FIG. 2 is a block diagram depicting components of calendar conflicts management system 102. In this example, system 102 includes invitation engine 202 and management action engine 204. In performing their respective functions, engines 202, 204 may access data repository 206. Repository 206 represents generally any memory accessible to system 102 that can be used to store and retrieve data.

Invitation engine 202 represents a combination of hardware and programming configured to access a current meeting invitation to a user, wherein there exists a timing conflict between the current invitation and another calendar event of the invitee user (the another event sometimes referred to herein as a “subject calendar event”). As used herein, a “meeting invitation” refers to any message that is to communicate an invitation to a meeting, gathering, call, conference, or other happening. In an example, the current meeting invitation may be a meeting invitation that has already been sent to the invitee user. In another example, the current meeting invitation may be a meeting invitation that is being prepared for sending, or otherwise has not yet been sent to the invitee user.

Management action engine 204 represents a combination of hardware and programming configured to access data indicative of calendar events. As used in this application, a “calendar event” refers generally to any gathering, meeting, occasion, anniversary, or other happening, and includes also includes any invitations, invitation acceptances, invitation rejections, and invitation counterproposals regarding attending such happening. In example, a calendar event may be a meeting, or a meeting invitation. The calendar event may be an electronic message that is shared by the invitee user, and a user that has initiated the current meeting invitation.

The management action engine 204 is additionally configured to access data indicative of a past behavior of the user following receipt of a meeting invitation, and to identify from such past behavior data, a relevant behavior with respect to a previous meeting invitation sent to the user. The previous meeting invitation is identified from the past behavior data, and has a same invitation attribute as the current meeting invitation. As used herein, an “invitation attribute” refers generally to any quality or feature regarding a meeting invitation. In examples, an invitation attribute that is identified may be one of a meeting type, a meeting subject, an invitee, and a number of invitees or participants.

The management action engine 204 is additionally configured to apply a management action to the current timing conflict. As used herein, a “management action” refers generally to any action taken to address, partially resolve, or resolve a meeting conflict. The management action is an action selected or generated by the management action engine 204 in consideration of the identified relevant behavior. As used herein, a “behavior” refers generally to any way in which a person one acts or conducts his or herself, e.g., in response to a situation or stimulus such as the receipt of a meeting invitation. Such a behavior may be evidenced by the person's interaction with one or more computing devices. In an example, the identified relevant behavior may be the invitee user causing sending of a rejection message to a meeting organizer user. In another example, the identified relevant behavior may be the invitee user causing sending of a timing counterproposal to a meeting organizer user. In another example, the identified relevant behavior may be invitee user's failure to respond to a meeting invitation sent by a meeting organizer user.

In another example, the identified relevant behavior may be the user's failure to attend all or part of a scheduled meeting. In an example, the management action engine 204 may access presence data from a client mobile computing device associated with the user, and identify the invitee user's failure to attend the previous meeting according to the presence data. As used herein, “presence data” refers generally to data that indicates a location or, state of a user or a computing device associated with a user. In an example, the presence data that is accessed and utilized to identify a failure to attend may be or include GIS data, GPS data, triangulation data, or other positioning data. In an example, the presence data that is accessed and utilized to identify a failure to attend may be motion analytics data, e.g. motion analytics data collected at a mobile computing device that analyzes user walk gait or other motions analytics to determine a particular user is utilizing the mobile device. In another example, the failure of the invitee user to attend the previous meeting may be identified by failure of the invitee user to access a telephone connection, web application, network, or other communications vehicle designated in a meeting invitation.

In an example, the management action that is to be applied by the management action engine 204 may be an action to remove the invitee user from the current meeting invitation. In another example, the management action that is applied by the management action engine 204 may be an action to send a message to the invitee user to request that the invitee user reschedule the subject calendar event that is conflict with the current meeting invitation. In yet another example, the management action that is applied by the management action engine 204 may be an action to implement a change in the current meeting invitation, e.g., a change to a different time on the same day, or a same time on a different day, or a different time on a different day. In an example, the management action engine 204 may cause the sending of the management action to a computing device (e.g. a computing device used by or associated with the invitee user) as a recommendation to be displayed to the invitee user, in another example, the management action engine 204 204 may cause the sending of the management action to a computing device used by or associated with a meeting organizer user that initiated sending of the current invitation to the first user. In yet another example, the management action engine 204 may automatically implement the management action.

FIG. 3 depicts an example implementation of data repository 206. In this example, repository 206 includes current invitation data 302 indicative of a current meeting invitation, calendar event data 304 indicative of calendar events, and behavior data 306 indicative of past behaviors of users following receipt of meeting invitations. Referring back to FIG. 2, the invitation engine 202 may access the current invitation data 302 that is indicative of a current meeting invitation to an invitee user that is in a timing conflict with a subject calendar event 316 of the invitee user. The invitation engine 202 and the management action engine 204 may access the calendar event 304. For instance, the calendar event data 304 may be data indicative of a calendar or schedule shared across a network and usable or viewable by employees of an enterprise. The management action engine 204 may access the behavior data 306 that is indicative of past behaviors of a set of users (that includes the invitee user) when such users received meeting invitations. The management action engine 204 may identify from the past behavior data 306 a relevant behavior 308 with respect to a previous meeting invitation 310 sent to the invitee user and having a same invitation attribute 312 as the current invitation 302. The management engine 204 may then apply a management action to the current timing conflict. The management action may be an action derived or generated, according to a formula that includes as a factor or otherwise considers the relevant behavior. In example, the management action may be an action selected from a set or group of potential or available management actions according to a formula that includes as a factor or otherwise considers the relevant behavior. In an example, the relevant behavior 308 that is identified may be with respect to a failure on the part of the invitee user to attend all or part of the previous meeting that was the subject of the previous meeting invitation 310. In an example, the management action engine 204 may access presence data 314. e.g., obtain presence data from a mobile computing device associated with the user, and identify the failure to attend relevant behavior utilizing the presence data 314. As discussed previously, the presence data 314 may include positioning data or motion analytics data. In examples, the presence data 314 may be data indicative that the invitee user failed to access a telephone connection, web application, or network that was designated in a meeting invitation or otherwise prescribed for the previous meeting. In an example, the failure to access may be complete or total failure to access. In another example, the failure to access may be a partial access, e.g., such as access that is for a period less than a meeting duration or other prescribed time period.

In another example, the management action engine 204 may access the calendar events data 304 to identify the relevant behavior 308 with respect to multiple meeting invitations sent to the invitee user and having a same invitation attribute 312 as the current meeting invitation 302. In this example, the management action engine 204 may be applied in consideration of a count of occurrences that the invitee user exhibited the relevant behavior 308.

In another example, the management action engine 204 may generate, identify, or select a management action, and apply the management action to the current conflict, in consideration of the identified relevant behavior 308 and also in consideration of a priority level 318 for the subject calendar event. In an example, the management action engine 204 may identify a priority level 318 of the subject calendar event 316 based upon a rule. In an example, the priority rule may assign the priority level 318 according to a number of invitees for the meeting. In another example, the priority rule may assign the priority level according to a number of participants for the meeting. In yet another example, the priority rule may assign the priority level according to whether the invitation for the subject calendar event 316 is sent by, or includes, a key user.

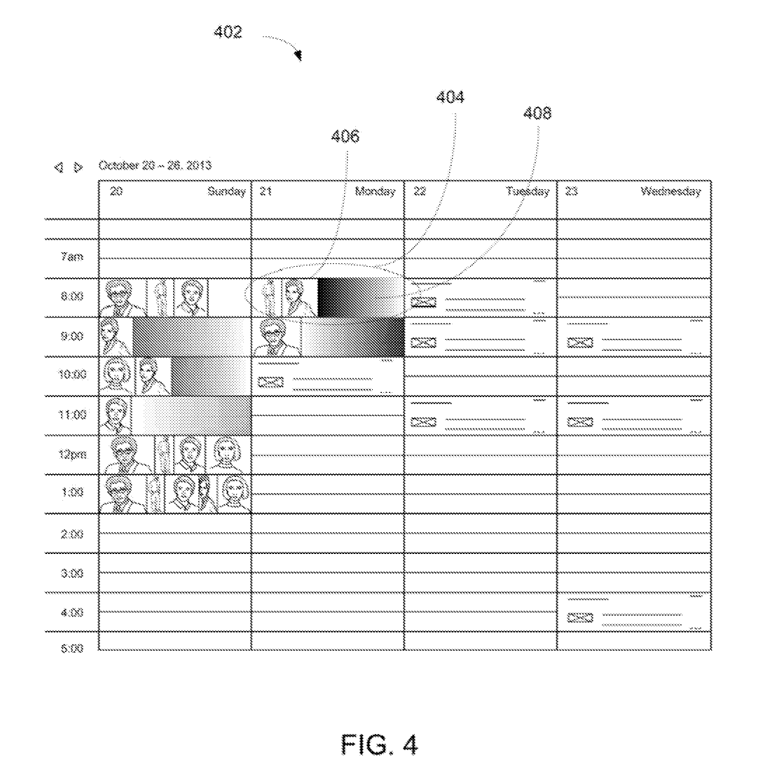

Moving to FIG. 4 in view of FIGS. 1-3, in a particular example the management action engine 204 may access calendar event data 304 to generate and display a calendar-view 402 of the subject calendar event 404 that is in conflict with the current meeting invitation. In this example the calendar view display 402 includes a graphical representation 406 of the invitee users. In another example, the representation 406 of the invitee users may be photographs or other digital representations of the invitee users. In another example, the representation of the invitee users may be text representations (e.g., a user names). In the example of FIG. 4 the calendar view display 402 additionally includes an indicator 408 of the priority level 318 of the subject calendar event 404 according the rule, In this example the indicator 408 of the priority level 318 is color coded. In an example, the color code priority for a high priority meeting may be red, and a color code priority for a low priority meeting may be blue.

In a particular example depicted in FIG. 4 in which the subject calendar event 404 has more than one invitee or participants, the indicator 408 may be representative of an average priority of the subject calendar event 316 that considers each of the multiple invitees. In an example, the average priority may be represented by a blending of the color code priorities for individual participants. For example, if a subject calendar event is a meeting or meeting invitation with two invitees, and if the meeting had been evaluated solely in consideration of a first invitee the color priority may be red, and if the meeting had been evaluated solely in consideration of a second invitee the color priority would have been blue, then the resulting blended or average priority color code indicator 408 for the subject calendar event may be a purple. Other color combinations than those described in the preceding paragraph are possible and contemplated by this disclosure.

In other examples, an indicator 408 for the priority level 318 of a subject calendar event 316 may be other than color coded. Examples include different black and white gradient patterns. For example, the priority level indicator for a high priority meeting may be a block with a black and white vertical striped pattern, and a priority indicator for a low priority meeting may be a block with no pattern or with a white background. In other examples, the priority level indicator may be a numeric or text representation. In an example wherein the priority level 318 of a subject calendar event 316 is to be expressed numerically, and the meeting has multiple participants, a blended or average priority indicator 408 can be generated that is a numerical average of the numerical meeting priorities that would be generated if the invitees were evaluated separately.

in the foregoing discussion, engines 202, 204 were described as combinations of hardware and programming. Engines 202, 204 may be implemented in a number of fashions. Looking at FIG. 5, the programming may be processor executable instructions stored on a tangible memory resource 502 and the hardware may include a processing resource 504 for executing those instructions. Thus memory resource 502 can be said to store program instructions that when executed by processing resource 504 implement system 102 of FIGS. 1 and 2.

Memory resource 502 represents generally any number of memory components capable of storing instructions that can be executed by processing resource 504. Memory resource 502 is non-transitory in the sense that it does not encompass a transitory signal but instead is made up of more or more memory components configured to store the relevant instructions. Memory resource 502 may be implemented in a single device or distributed across devices. Likewise, processing resource 504 represents any number of processors capable of executing instructions stored by memory resource 502. Processing resource 504 may be integrated in a single device or distributed across devices. Further, memory resource 502 may be fully or partially integrated in the same device as processing resource 504, or it may be separate but accessible to that device and processing resource 504.

In one example, the program instructions can be part of an installation package that when installed can be executed by processing resource 504 to implement system 102. In this case, memory resource 502 may be a portable medium such as a CD, DVD, or flash drive or a memory maintained by a server from which the installation package can be downloaded and installed. In another example, the program instructions may be part of an application or applications already installed. Here, memory resource 502 can include integrated memory such as a hard drive, solid state drive, or the like.

In FIG. 5, the executable program instructions stored in memory resource 502 are depicted as an invitation module 506, an event module 508, a behavior module 510, an identification module 512, and a management module 514, Invitation module 506 represents program instructions that when executed cause processing resource 504 to cause the implementation of invitation engine 202 of FIG. 2. Event module 508 represents program instructions that when executed cause processing resource 504 to cause the implementation of a portion of management action engine 204 of FIG. 2. Specifically, the event module 508 causes accessing of data indicative of calendar events. Behavior module 510 represents program instructions that when executed cause processing resource 504 to cause the implementation of a portion of management action engine 204 of FIG. 2. Specifically, the behavior module 510 causes accessing of data indicative of a past behavior of the invitee user following receipt of a meeting invitation. Identification module 512 represents program instructions that when executed cause processing resource 504 to cause the implementation of a portion of management action engine 204 of FIG. 2. Specifically, the identification module 512 causes identifying, from the past behavior data, of a relevant user behavior with respect to a previous meeting invitation sent to the user. The previous meeting invitation and the current invitation share a common invitation attribute.

Management module 514 represents program instructions that when executed cause processing resource 504 to cause the implementation of a portion of management action engine 204 of FIG. 2. Specifically, the management module 514 causes application of a management action to the current timing conflict. The management action is generated, derived, or selected in consideration of the relevant behavior identified by the identification module 512.

### Operation

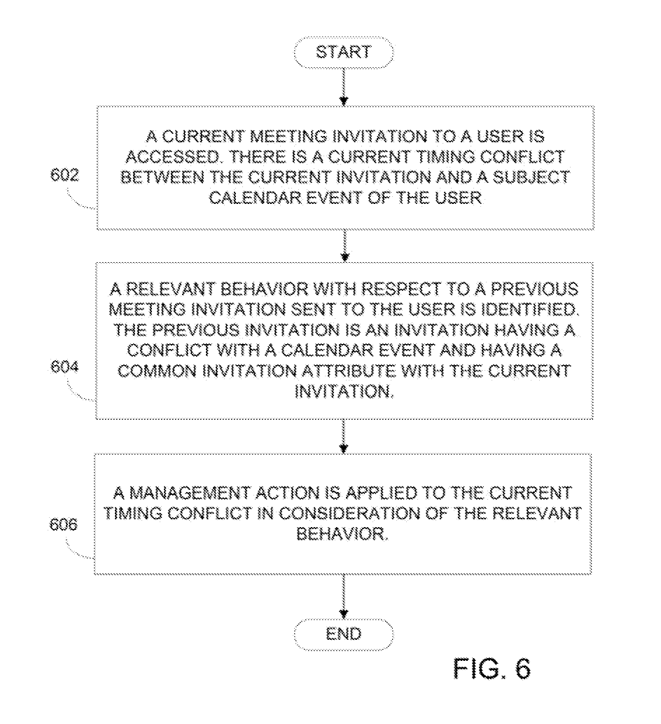

FIG. 6 is a flow diagram of steps taken to implement a method for applying management actions to calendar conflicts. In discussing FIG. 6, reference may be made to the components depicted in FIGS. 2 and 5. Such reference is made to provide contextual examples and not to limit the manner in which the method depicted by FIG. 6 may be implemented.

A current meeting invitation to a user is accessed. There is a current timing conflict between the current invitation and a subject calendar event of the user (block 602). Referring back to FIGS. 2 and 5, invitation engine 202 (FIG. 2) or invitation module 506 and event module 508, when executed by processing resource 504, may be responsible for implementing block 602.

A relevant behavior with respect to a previous meeting invitation sent to the user is identified. The previous invitation is an invitation having a conflict with a calendar event and having a common invitation attribute with the current invitation (block 604). Referring back to FIGS. 2 and 5, management action engine 204 (FIG. 2), or behavior module and identification modules 512, 514, when executed by processing resource 504, may be responsible for implementing block 604.

A management action is applied to the current timing conflict in consideration of the relevant behavior (block 606). Referring back to FIGS. 2 and 5, management action engine 204 (FIG. 2), or management module 514, when executed by processing resource 504, may be responsible for implementing block 606.

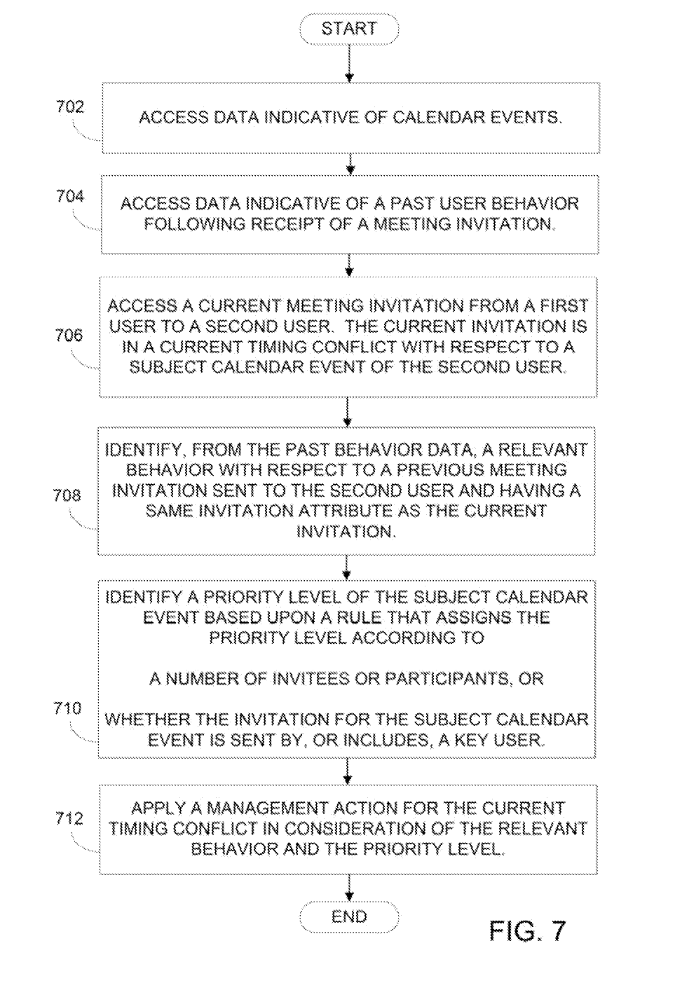

FIG. 7 is a flow diagram of steps taken to implement a method for applying management actions to calendar conflicts. In discussing FIG. 7, reference may be made to the components depicted in FIGS. 2 and 5. Such reference is made to provide contextual examples and not to limit the manner in which the method depicted by FIG. 7 may be implemented.

Data indicative of calendar events is accessed (block 702). Referring back to FIGS. 2 and 5, management action engine 204 (FIG. 2) or event module 508, when executed by processing resource 504, may be responsible for implementing block 702.

Data indicative of a past user behavior following receipt of a meeting invitation is accessed (block 704). Referring back to FIGS. 2 and 5 management action engine 204 (FIG. 2) or behavior module 510, when executed by processing resource 504, may be responsible for implementing block 704.

A current meeting invitation from a first user to a second user is accessed. The current invitation is in a current timing conflict with respect to a subject calendar event of the second user (block 706). Referring back to FIGS. 2 and 5, invitation engine 202 (FIG. 2) or invitation module 506, when executed by processing resource 504, may be responsible for implementing block 706.

A relevant behavior is identified from the past behavior data. The relevant behavior is with respect to a previous meeting invitation sent to the second user. The previous meeting invitation has a same invitation attribute as the current invitation (block 708). Referring back to FIGS. 2 and 5, management action engine 204 (FIG. 2) or behavior module 510, when executed by processing resource 504 may be responsible for implementing block 708.

A priority level of the subject calendar event is identified according to a rule. In an example, the rule may consider a number of invitees or participants. In another example, the rule may consider whether the invitation for the subject, calendar event is sent by, or includes, a key user (block 710). Referring back to FIGS. 2 and 5, management action engine 204 (FIG. 2) or identification module 512, when executed by processing resource 504, may be responsible for implementing block 710.

A management action is applied to the current timing conflict. The management action is an action generated or selected according to a formula or rule that is considers the identified relevant behavior and the identified priority level (block 712). Referring back to FIGS. 2 and 5, management action engine 204 (FIG. 2) or management module 514, when executed by processing resource 504, may be responsible for implementing block 712.

### CONCLUSION

FIGS. 1-7 aid in depicting the architecture, functionality, and operation of various embodiments. In particular, FIGS. 1-2 and 4-5 depict various physical and logical components. Various components are defined at least in part as programs or programming. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Embodiments can be realized in any memory resource for use by or in connection with processing resource. A “processing resource” is an instruction execution system such as a computer/processor based system or an ASIC (Application Specific integrated Circuit) or other system that can fetch or obtain instructions and data from computer-readable media and execute the instructions contained therein. A “memory resource” is any non-transitory storage media that can contain, store, or maintain programs and data for use by or in connection with the instruction execution system. The term “non-transitory is used only to clarify that the term media, as used herein, does not encompass a signal. Thus, the memory resource can comprise any one of many physical media such as, for example, electronic, magnetic, optical, electromagnetic, or semiconductor media. More specific examples of suitable computer-readable media include, but are not limited to, hard drives, solid state drives, random access memory (RAM), read-only memory (ROM), erasable programmable read-only memory, flash drives, and portable compact discs.

Although the flow diagrams of FIGS. 6 and 7 show specific orders of execution, the orders of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What claimed is:

1. A memory resource storing instructions that when executed cause a processing resource to implement a system for applying management actions to calendar conflicts, the instructions comprising:
an invitation module for accessing a current meeting invitation to a user, wherein there is a current timing conflict between the current invitation and a subject calendar event of the user;
an event module for accessing data indicative of calendar events;
a behavior module for accessing data indicative of a past behavior of the user following receipt of a meeting invitation;
an identification module for identifying, from the past behavior data, a relevant behavior with respect to a previous meeting invitation sent to the user and having a same invitation attribute as the current invitation; and
a management module for applying, in consideration of the relevant behavior, a management action to the current timing conflict.

2. The medium of claim 1,
wherein the relevant behavior is identified with respect to a plurality of previous meeting invitations sent to the user and having the same invitation attribute; and
wherein applying the management action occurs in consideration of a count of occurrences that the user exhibited the relevant behavior.

3. The medium of claim 1 wherein the management action includes at least one of
removing the user from he current meeting invitation,
sending a message to the user requesting rescheduling of the subject calendar event, and
changing the time or date of the current meeting invitation.

4. The medium of claim 1,
wherein the user is a first user; and
wherein the instructions cause the system to send the management action to a computing device as a recommendation to be displayed to the first user, or to a second user that initiated sending of the invitation to the first user.

5. The medium of claim 1, wherein the invitation attribute includes at least one of a meeting type, a meeting subject, an invitee, and a number of invitees or participants.

6. The medium of claim wherein the relevant behavior is the user causing sending of a rejection message or a timing counterproposal.

7. The medium of claim 1, wherein the relevant behavior is a failure to respond.

8. A system for applying management actions to calendar conflicts, comprising:
an invitation engine, to access a current meeting invitation to a user, wherein there is a current timing conflict between the current invitation and a subject calendar event of the user;
a management action engine, to
identify a relevant behavior with respect to a previous meeting invitation sent to the user, the previous invitation having
a conflict with a calendar event,
a common invitation attribute with the current invitation; and
apply, in consideration of the relevant behavior, a management action to the current timing conflict.

9. The system of claim 8, wherein the relevant behavior is a failure to attend all or part of a meeting.

10. The system of claim 9, wherein the instructions cause the system to access presence data and the failure to attend is identified utilizing the presence data.

11. The system of claim 10, wherein the presence data includes positioning data or motion analytics data.

12. The system of claim wherein the failure to attend is identified by failure of the user to access a telephone connection, web application, or network designated in a meeting invitation.

13. A method for applying management actions to calendar conflicts, comprising:
accessing data indicative of calendar events;
accessing data indicative of a past user behavior following receipt of a meeting invitation;
accessing a current meeting invitation from a first user to a second user, wherein the current invitation is in a current timing conflict with respect to a subject calendar event of the second user;
identifying, from the past behavior data, a relevant behavior with respect to a previous meeting invitation sent to the second user and having a same invitation attribute as the current invitation;
identifying a priority level of the subject calendar event based upon a rule that assigns the priority level according to
a number of invitees or participants, or
the invitation for the subject calendar event is sent by, or includes, a key user; and
applying a management action to the current timing conflict in consideration of the relevant behavior and the priority level.

14. The method of claim 13, further comprising:
accessing data to cause a calendar-view display of the subject calendar event including
a representation of the second user; and
an indicator of the priority level of the subject calendar event according the rule.

15. The method of claim 13, wherein the subject calendar event has a plurality of invitees and the indicator is representative of an average priority of the subject calendar event in consideration of the plurality of invitees.
